(19) United States
(12) Patent Application Publication
(10) Pub. No.: US 2017/0075343 A1
(43) Pub. Date: Mar. 16, 2017

(54) FIELD DEVICE, METHOD FOR OPERATING A FIELD DEVICE AND CLOUD SERVICE

(71) Applicant: KROHNE Messtechnik GmbH, Duisburg (DE)

(72) Inventors: Christian HANSEN, Hattingen (DE); Christoph SPIEGEL, Oberhausen (DE)

(73) Assignee: KROHNE Messtechnik GmbH, Duisburg (DE)

(21) Appl. No.: 15/309,247

(22) PCT Filed: May 8, 2015
(86) PCT No.: PCT/EP2015/060213

§ 371 Date: Nov. 7, 2016

(30) Foreign Application Priority Data
May 12, 2014 (DE) 10 2014 106 632.4

(51) Int. Cl. G05B 19/418

(52) U.S. Cl. CPC G05B 19/4185; G05B 2219/31104; G05B 2219/32126; G05B 2219/32136

(57) ABSTRACT

A field device (1) and interface (2), a method for operating a field device (1) as well as a cloud service that achieve simplified data communication is obtained in that the interface is a cloud interface (2) via which data communication takes place between the field device (1) and a cloud (3).

### BACKGROUND OF THE INVENTION

Field of the Invention

The invention relates to a field device. Furthermore, the invention relates to a method for operating a field device. Finally, the invention also relates to a cloud service.

Description of Related Art

In modern process automation, it is common to monitor processes or media using field devices in the form of measuring devices (sensors) or, respectively, to influence processes or media using field devices in the form of control elements (actuators).

Generally speaking, field devices are connected to control rooms that are part of a process control system for managing processes. For this, so-called fieldbuses having appropriate protocols are often used (e.g., EtherNet/IP, PROFINET, Modbus TCP, Foundation Fieldbus (FF), Profibus DP or PA, Modbus RTU).

Hereby, data is transmitted from the field devices to the control room, or the field devices receive data, e.g., parameter values, or software components, etc. from the control room.

One disadvantage is that the data and access possibilities are, generally speaking, limited to the process control system, in which the control room and the field devices are located. Data outside of the processing system, thus, cannot normally be accessed. In the case of field devices that are widely distributed, in some instances, data access is only directly possible from the field device itself. A decentralized water supply system is an example of such.

### SUMMARY OF THE INVENTION

Thus, the object of the invention is to simplify data communication with field devices.

The field device according to the invention, in which the derived and described object is achieved, is initially and essentially characterized in that at least one cloud interface is provided, via which data communication between the field device and a cloud takes place.

A demand-driven supply of data processing resources of any type that allows for the processing or storing of data on different units is called cloud. However, cloud can also be understood as a server (e.g., file server, e-mail server, database server, etc'.) accessible via a network, in which at least the field device is located, or via the internet. Thereby, it is possible to flexibly increase the computing capacity during a specific application, when complicated calculations etc. are necessary. Furthermore, for example, stored data is available using different routes and using different access points.

According to the invention, a cloud interface is provided, via which data can be exchanged between such a cloud and a field device, i.e., via which the field device is able to transmit data and/or receive data.

In general, bidirectional data transfer between cloud and field device is possible. Data transfer can take place according to a fixed schedule or, for example, as the result of a query. Furthermore, a transfer purely of data can be supplemented with an acknowledgment from the receiving side.

In one design, the field device itself has an interface, which is, thus, a component of the field device.

In an alternative design, the field device has a standard interface, which, for example, allows connection to a fieldbus according to the prior art. The cloud interface, thereby, is a component of a separate communication device, so that the field device communicates with the communication device via the standard interface and the communication device communicates with the cloud via the cloud interface. Thus, in this design, it is possible that the field device is a normal field device according to the prior art that exchanges data with the cloud via a separate communication device.

In particular, if the field device is autonomous or, for example, should a repeated query be avoided, then it is provided in one design that the field device transmits data to the cloud and/or receives data from the cloud according to a predefined time schedule.

The time schedule relates, for example, to a time span between the transmission and/or receipt of data. The field device is alternatively given a specific time plan, in particular in conjunction with a real-time device.

If the field device is a measuring device, then the field device accordingly starts measurement so that the measured value or, possibly, several measured values can be transmitted in the form of data at the appropriate point in time.

In one design, a time schedule is stored in the cloud so that the cloud sends a query signal to the field device and/or to several field devices according to the schedule. Additionally or alternatively, the time schedule is stored in at least one field device so that the field device transmits data to the cloud autonomously and without a query from the cloud.

Additionally or alternatively, in one design, query signals are transmitted outside of a fixed time schedule to the field device or, respectively, to the cloud. This relates, for example, to a manual query of measured values or to the transfer of configuration data or, for example, a firmware update.

It is provided in one design that the field device intermittently goes into energy-saving mode. Hereby, for example, components are not supplied with energy or only with reduced energy, or certain functions are not carried out. This design is particularly advantageous when the field device, for example, has only a battery or power pack, or generally has only its own, limited supply of energy, e.g., by means of an energy harvester in the form of a solar module.

It is provided in one design that the field device transmits data to the cloud and/or retrieves a piece of information from the cloud after receiving a query signal. In this design, the field device receives a query signal, which, for example, moves it out of the energy-saving mode and which informs the field device that it needs to be active. In one design, this consists of the field device transmitting data to the cloud, i.e., for example, it carries out a measurement and transmits at least one measured value to the cloud. In an alternative design, the field device is informed by the cloud which data or which information the field device should provide. This, for example, is related to the field device transmitting data that is not found in the normal data volume, e.g., information about the state of the field device or about versions of software or individual components of the field device or its operating time, etc.

According to a further teaching of the invention, the above object is achieved by a method for operating a field device that is characterized at least in that data is communicated between the field device and a cloud via a cloud interface.

The field device thereby conforms with one of the above-described designs.

For example, data access or the control of a processing system, in which at least one field device is located, is simplified according to the invention in that data is communicated between the field device and a cloud via a cloud interface.

Thereby, in one design, an activation process is provided so that it is ensured that the at least one field device communicates only with the correct cloud.

At least in the activation process, at least an activation code is thereby transmitted to the field device from the cloud. The activation code preferably contains at least one piece of information about the cloud or, preferably, about the instance that the cloud provides as service.

After receiving the activation code, i.e., after the field device has been informed by the activation code that a connection is to be generated between the cloud sending the activation code and the field device, a verification of the received activation code is made possible by the field device.

This means that, in one design, the field device shows the activation code or a piece of information obtained therefrom on a display unit. In the positive case, the display is acknowledged by a used, so that the field device can communicate with the cloud in question.

In a further design, a mechanism is described, though which the field device is made to transmit data to the cloud.

It is thereby provided that a query signal is transmitted to the field device.

In one design, the query signal can, thereby, be implemented as an arbitrarily short data packet, since the query signal itself does not transmit information, but rather the information consists of the field device receiving such a query signal. Thus, it is sufficient when it is clear that this is such a query signal.

As a consequence of the received query signal, in one design, information is retrieved from the cloud by the field device. Based on the relevant information transmitted back from the cloud, the field device transmits data to the cloud. Thus, in this design, the field device inquires which data is to be transmitted to the cloud.

Alternatively, data is transmitted to the cloud from the field device after receiving the query signal. Thus, the field device automatically reacts to the query signal in this design in that it transmits data to the cloud.

It is provided in a further alternative design that, after the query signal is received by the field device, data from the cloud is received. In one variation, the field device reacts to receiving the query signal in that it inquires about information from the cloud and then receives the information from the cloud that data, e.g., configuration data or a software update, is available to be downloaded for the field device, i.e., available for data receipt. In an alternative variation, the query signal already comprises this information in respect to new data for the field device, so that the field device receives or picks up new data from the cloud directly after receiving the query signal.

The transmitted data is, for example, measured values, or is data that more exactly characterizes the field device or its current state.

In one design, the receipt of data is respectively acknowledged or confirmed. It is thus provided in one variation that the receipt of data is acknowledged by the cloud to the field device. In an additional or alternative variation, it is provided that the receipt of data is acknowledged by the field device to the cloud.

One design consists of the receipt of data being acknowledged in that at least a point in time for at least a subsequent data transfer is transmitted. In one design, the receipt of data is acknowledged in that at least a new time schedule is transmitted, wherein the time schedule consists of at least a point in time, in which a subsequent, i.e., next data transfer is to take place.

It is provided in one design that the receipt of data is acknowledged by the cloud to the field device, in that the field device is transmitted a point in time for at least a subsequent data transfer from the field device to the cloud, and/or that the receipt of data is acknowledged by the field device to the cloud, in that the cloud is transmitted a point in time for at least a subsequent data transfer from the cloud to the field device.

In respect to the time schedule, after the field device has autonomously transmitted data to the cloud, it is provided in one design that the receipt of data is acknowledged by the cloud to the field device, in that the field device is transmitted a point in time for at least a subsequent data transfer from the field device to the cloud. The receipt of data is thus acknowledged in that the field device receives a point in time for at least a next transmission of data to the cloud.

Additionally or alternatively, it is provided in one design that the receipt of data is acknowledged by the field device to the cloud in that the cloud is transmitted a point in time for at least a subsequent data transfer from the cloud to the field device.

In a further design, several points in time are communicated, for example in that the time span between a predetermined number of successive data transfers is provided.

According to a further teaching, the above object is achieved by a cloud service, via which data communication with at least one field device is implemented.

Thus, data communication is implemented according to the invention in that a respective cloud or a cloud service is provided, via which data communication takes place with at least one field device. Thus, using corresponding processing units or storage units that are a part of the processing unit in one design, a cloud service is provided, via which at least one field device is addressed or to which at least one field device can transmit its data.

In one design, the cloud service is thereby provided using the user's components and, in another design, is provided as an external service.

The above explanations in respect to the field device or the method and the advantages mentioned there are accordingly valid for the cloud service or, respectively can be implemented using it.

In one design, the at least one field device with the cloud is part of a processing system.

In detail, there is a plurality of possibilities for designing and further developing the field device according to the invention, the method according to the invention as well as the cloud service will become apparent from the following description of embodiments in conjunction with the drawing.

### BRIEF DESCRIPTION OF THE DRAWINGS

FIG. 1 is a schematic representation of a processing system,

FIG. 2 is a schematic representation of a processing system in an alternative embodiment,

FIG. 3 is a flow diagram of an embodiment of a procedure for communication between a field device and a cloud,

FIG. 4 is a flow diagram of an embodiment of a method procedure that follows the procedure shown in FIG. 3.

### DETAILED DESCRIPTION OF THE INVENTON

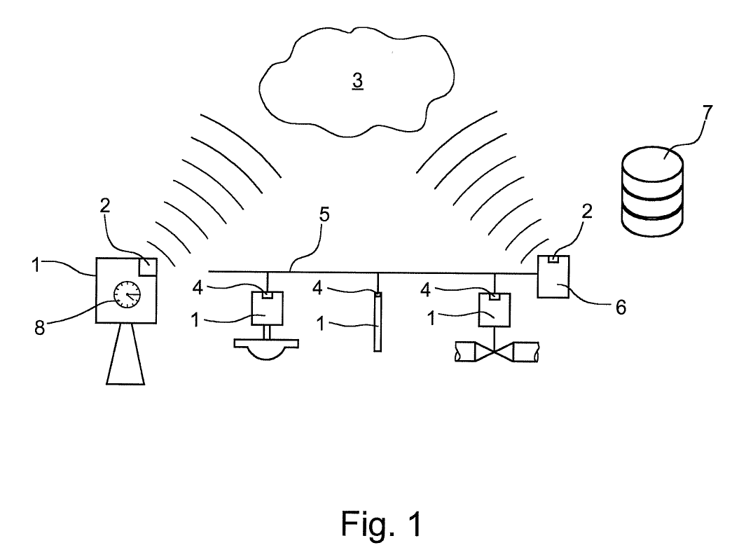

A processing system is shown highly schematically in FIG. 1, in which several field devices 1 are provided. However, this is only one embodiment, since the invention can also be implemented with only one field device 1. This is thereby, in some instances, a measuring device (for fill level, flow or pH values) and, in one case, a control element in the form of a valve.

The separately arranged field device 1 for determining fill level is provided with its own cloud interface 2, which allows for communication with a cloud 3.

Data transfer is wireless in the illustrated embodiment, e.g., using radio wireless technology. Alternatively, the cloud interface is an ethernet based interface or an interface to a data service of cellular mobile communications (e.g., GPRS—for General Packet Radio Service—or HSPA for High Speed Packet Access).

The other field devices 1 have a standard interface 4 for connection to a communication device 6 via a fieldbus 5. The communication device 6 has a cloud interface 2 and thus allows for communication with the cloud 3 via the fieldbus 5 with its connected field devices 1 in the sense of a gateway.

The cloud 3 is implemented by a computing device 7, which provides the corresponding cloud service. The computing device 7 is, thereby, in the shown embodiment, a component of the processing system itself.

In an alternative embodiment (not shown), the computing device 7 is operated by an external instance that offers cloud services.

The field devices 1 have real-time devices 8 which allow the data that is to be transmitted to be provided with a time stamp, and, additionally, allow measurement and/or data transfer to be carried out at previously defined points in time.

Synchronizing the data of the field devices 1 is carried out in conjunction with the cloud service, for example with the help of a technology such as the Network Time Protocol (NTP) with a reference time.

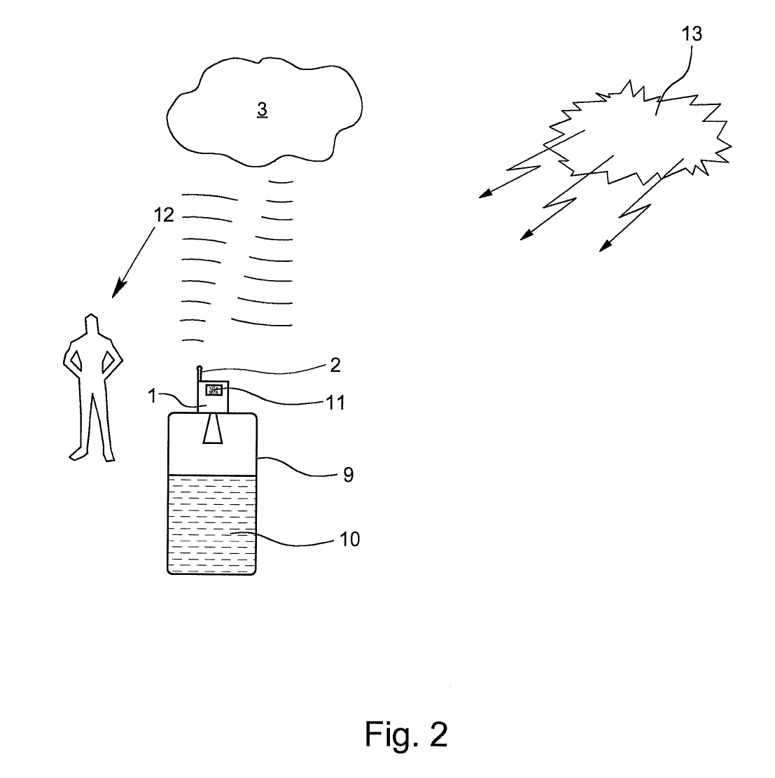

An activation process of a field device 1 is schematically shown in FIG. 2.

Thereby, the field device 1 is attached to the upper side of a container 9 and is designed as a measuring device for determining the fill level of the medium 10.

The cloud 3 transmits an activation code to the field device 1 for a first connection between the field device 1 and the cloud 3. This takes place, here, via a wireless connection and the cloud interface 2.

The activation code is shown via a display/input device 11 in the form of a human-machine interface. The code is verified by a user 12 and the field device 1 is activated for communication with the cloud 3.

In that connection is only allowed with a known cloud 3, it is prevented that, e.g., an interception cloud 13 starts contact and that data thereby reaches an incorrect recipient.

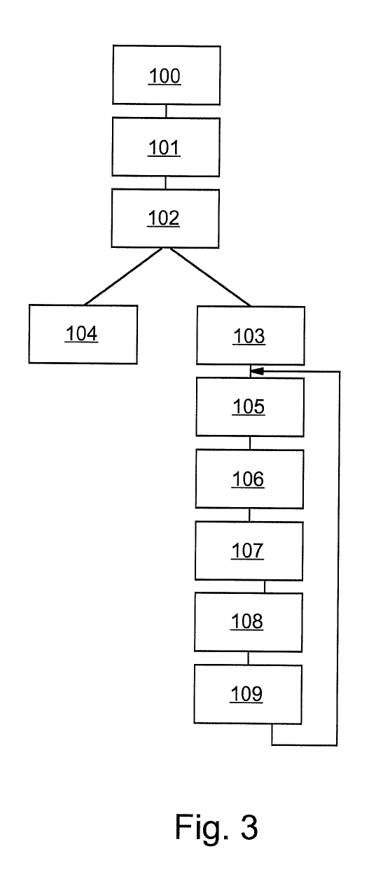

A procedure for communication between a field device, which acts as a sensor, and a cloud is shown in FIG. 3.

In step 100, the field device is mounted at a measuring site. In a possibly provided further step, the field device is, for example, added to or made known to the cloud by means of a unique identification (e.g., phone number of the SIM card, serial number).

In step 101, the field device receives an activation code coming from the cloud, which distinguishes and identifies the specific cloud. This takes place, for example, in the form of an SMS.

The activation code is verified by the user or by the service personnel in step 102, so that in the positive case, the field device communicates with the cloud starting at step 103.

In the case that the activation code does not originate from a permitted cloud, the connection is rejected, wherein, in step 104 here, in particular, a signalization is generated that non-permissible connection was attempted.

In step 105, the field device goes into energy-saving mode, in that, for example, in particular, the components used for measurement in the field device are no longer supplied with energy.

In step 106, the field device goes back into the measuring state according to a time schedule stored in the field device and determines a measured value.

In step 107, the measured value is thereby transmitted to the cloud as a raw value, the cloud, in step 108, determining the actual value for the process variable from the raw value.

Furthermore, the measurement data from several field devices is centrally managed by and preferably also stored in the cloud.

In step 109, the cloud transmits a confirmation signal as acknowledgement for the measured value to the field device, whereupon the field device goes into the energy-saving mode again in step 105.

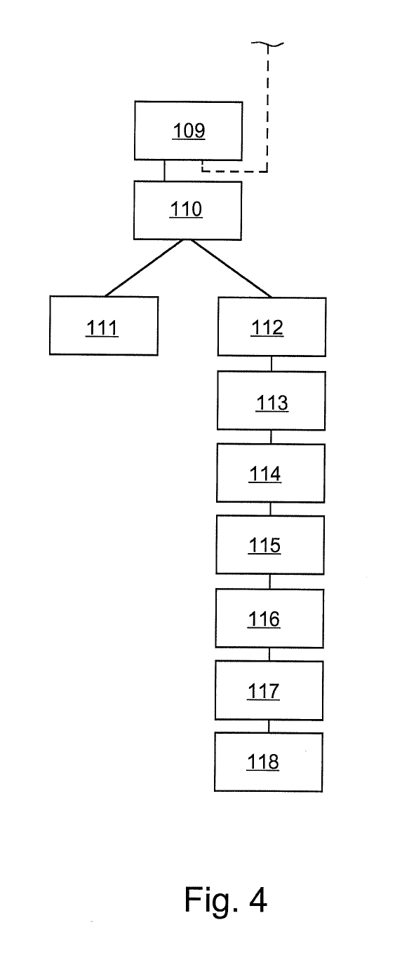

An alternative scenario is shown in FIG. 4, in which a measured value is required at a point in time outside of the time schedule stored in the field device.

For this, in order to obtain a current measured value, a query signal is transmitted to the field device after step 109, in step 110.

The query signal, in one case, leads to the field device automatically generating a measured value and transmitting it to the cloud in step 111.

In an alternative case, the field device inquires at the cloud in step 112, which measured data or which information is required.

In step 113, the cloud transmits a corresponding request to the field device, which is then carried out by the field device in step 114.

In the illustrated embodiment, the next point in time for transmitting a measured value is transmitted from the cloud to the field device in step 115. This means that, for the subsequent steps, the time schedule is reduced to one point in time, namely the next measurement.

Accordingly, the field device goes into energy-saving mode in step 116, in order to then, in step 117, generate the measured value and transmit it to the cloud.

The field device receives the next point in time for transmitting or, with it, possibly also generating the measured value from the cloud as acknowledgement. The point in time for determining the measured value and data transfer can, thereby, be different. Thus, it is provided in one embodiment that the field device determines a preset number of measured values and then transmits them collectively.

What is claimed is:

1-12. (canceled)

13. Field device and at least one cloud interface via which data communication takes place between the field device and a cloud.

14. The field device according to claim 13, wherein the interface is a component of the field device.

15. The field device according to claim 13, wherein the field device has a standard interface, wherein the cloud interface is a component of a communication device, and wherein the field device communicates with the communication device via the standard interface.

16. The field device according to claim 13, wherein the field device has means to transmit data to the cloud and/or receive data from the cloud according to a predefinable time schedule.

17. The field device according to claim 13, wherein the field device has means for intermittently going into an energy-saving mode.

18. The field device according to claim 13, wherein the field device has means to transmit data to the cloud and/or retrieve a piece of information from the cloud after receiving a query signal.

19. Method for operating a field device, comprising:
communicating data between the field device and cloud via a cloud interface.

20. The method according to claim 19, wherein, at least in an activation process, at least one activation code is transmitted to the field device from the cloud, wherein, after receiving the activation code, verification of the received activation code is performed by the field device, and wherein, after successful verification, the field device communicates with the cloud.

21. The method according to claim 19, wherein a query signal is transmitted to the field device, wherein, after receiving the query signal, information is retrieved from the cloud, and, based on the information retrieved, data is transmitted to the cloud from the field device.

22. The method according to claim 19, wherein a query signal is transmitted to the field device, after receiving the query signal, data is transmitted to the cloud from the field device.

23. The method according to claim 19, wherein a query signal is transmitted to the field device, after receiving the query signal, data from the cloud is received by the field device.

24. Method according to claim to 22, wherein the receipt of data is acknowledged by the cloud to the field device

25. Method according to claim to 23, wherein the receipt of data is acknowledged by the field device to the cloud.

26. Method according to claim 25, wherein, when receipt of data is acknowledged, at least one point in time for at least one subsequent transfer of data is transmitted.

27. Method according to claim 24, wherein, when receipt of data is acknowledged, at least one point in time for at least one subsequent transfer of data is transmitted.

28. Cloud service, via which data communication with at least one field device is implemented.
